(19) United States
(12) Patent Application Publication
(10) Pub. No.: US 2009/0192983 A1
(43) Pub. Date: Jul. 30, 2009

(54) METHOD AND SYSTEM FOR MINING, RANKING AND VISUALIZING LEXICALLY SIMILAR SEARCH QUERIES FOR ADVERTISERS

(75) Inventor: Pradheep Elango, Mountain View, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/021,105

(22) Filed: Jan. 28, 2008

(51) Int. Cl. G06F 17/30

(52) U.S. Cl. 707/3; 707/E17.001

(57) ABSTRACT

Methods, systems, and apparatuses for analyzing query logs and for generating query-related information useful to entities, such as advertisers, are provided. Entities, such as advertisers, may display content, such as advertisements, on search engine websites in response to particular queries. A search engine may store a query log listing a record of queries submitted by users to the search engine. Information may be generated regarding listed queries that did not lead to a click of content of an entity displayed on the search engine website. Information may also be generated providing query recommendations to the entities.

### BACKGROUND OF THE INVENTION

1. Field of the Invention

The present invention relates to search engine query logs, and in particular, to the extracting of query-related information relevant to entities, such as advertisers, from search engine query logs.

2. Background Art

A search engine is an information retrieval system used to locate documents and other information stored on a computer system. Search engines are useful at reducing an amount of time required to find information. One well known type of search engine is a Web search engine which searches for documents, such as web pages, on the “World Wide Web.” Examples of such search engines include Yahoo! Search™ (at http://www.yahoo.com), Ask.com™ (at http://www.ask.com), and Google™ (at http://www.google.com). Online services such as LexisNexis™ and Westlaw™ also enable users to search for documents provided by their respective services, including articles and court opinions. Further types of search engines include personal search engines, mobile search engines, and enterprise search engines that search on intranets, among others.

To perform a search, a user of a search engine supplies a query to the search engine. The query contains one or more words/terms, such as “hazardous waste” or “country music.” The terms of the query are typically selected by the user to as an attempt find particular information of interest to the user. The search engine returns a list of documents relevant to the query. In a Web-based search, the search engine typically returns a list of uniform resource locator (URL) addresses for the relevant documents. If the scope of the search resulting from a query is large, the returned list of documents may include thousands or even millions of documents.

A search engine may generate a query log, which is a record of searches that are made using the search engine. A search engine query log lists query terms along with further information/attributes for each query, such as one or more documents resulting from a search using each particular query, an indication of whether any of the resulting documents were clicked, rankings of the resulting documents, etc. A search engine query log may be very large, potentially including information regarding thousands or even millions of queries.

Advertisers that advertise on search engine websites may desire information regarding the success of their advertisements. For example, an advertiser-specific query log may be generated from the search engine query log to provide information regarding queries that relate to the specific advertiser. An advertiser query log may list queries that resulted in display of advertisements of the advertiser, and may indicate whether or not the displayed advertisements were clicked on by users. However, advertiser query logs do not provide information to advertisers about other types of queries, including information regarding queries that did not lead to advertisements of advertisers to be displayed, but that may still be of interest to advertiser.

Thus, what is desired are ways of extracting useful information from query logs for entities (e.g., advertisers) regarding queries other than those that led to the advertiser's advertisements to be displayed.

### BRIEF SUMMARY OF THE INVENTION

Methods, systems, and apparatuses for analyzing query logs and for generating query-related information useful to entities, such as advertisers, are provided. Entities, such as advertisers, may provide content, such as advertisements, for display on search engine websites in response to particular queries. A search engine may store a query log listing a record of queries submitted by users to the search engine. Information may be generated and provided to an entity regarding queries listed in the query log that did not lead to content of the entity being displayed on a search engine website. Furthermore, query recommendations may be generated and provided to the entity based on an analysis of the query log.

In a first example aspect of the present invention, a no-click query report is generated. Related queries in a search query log are grouped into one or more groups of related queries. A clicked query is selected from an entity-specific query log that lists queries associated with an entity. A query group associated with the selected clicked query is selected from the one or more groups of related queries. One or more queries of the selected query group are determined that are not listed in the entity-specific query log. The determined one or more queries are listed in a query report. Further clicked queries and query groups may be processed to determine further queries to be listed in the query report.

In an example, a hash may be generated from the entity-specific query log. A determination of whether a query is listed in the entity-specific query log may be made by generating a hash of the query and comparing the hash of the query to the hash of the entity-specific query log.

In another example aspect of the present invention, a query recommendation report is generated. Related queries listed in a search query log are grouped into one or more groups of related queries. A normalized total click frequency (NTCF) is calculated for each clicked query listed in an entity-specific query log that lists queries associated with an entity. For each clicked query listed in the entity-specific query log: the clicked query is selected from the entity-specific query log, a query group associated with the selected clicked query is selected from the one or more groups of related queries, and a normalized group click frequency (NGCF) is calculated for each query of the selected query group. Relevancy scores are calculated for a plurality of queries based on the calculated NTCFs and NGCFs.

For instance, in one example, a relevancy score for a query q′ of the plurality of queries may be calculated according to

$$score ( {q}^{′} ) = {\sum }_{q ∈ Q} NGCF ( {q}^{′} \vert q ) \times NTCF ( q ) ,$$

where
Q=the set of clicked queries listed in the entity-specific query log,
NGCF(q′|q)=the calculated normalized group click frequency for query q′ for the query group associated with the selected clicked query q,
NTCF(q)=the calculated normalized total click frequency for the clicked query q.

In another example aspect of the present invention, a first query information reporting system is provided. The first query information reporting system includes a query log sorter and a no-click query determiner. The query log sorter is configured to group related queries in a search query log into one or more groups of related queries. The no-click query determiner is configured to select a clicked query from an entity-specific query log that lists queries associated with an entity, and to select a query group associated with the selected clicked query from the one or more groups of related queries. The no-click query determiner is configured to determine any query of the selected query group that is not listed in the entity-specific query log.

In an example, the first query information reporting system includes one or more hash generators configured to generate a hash of the entity-specific query log, and a hash of queries of the selected query group. The generated hashes are used in a comparison to determine whether the queries of the selected query group are not listed in the entity-specific query log.

In another example aspect of the present invention, a second query information reporting system is provided. The second query information reporting system includes a query log sorter, a first calculator, a second calculator, and a third calculator. The query log sorter is configured to group related queries in a search query log into one or more groups of related queries. The first calculator is configured to calculate a normalized total click frequency (NTCF) for each query listed in an entity-specific query log that lists queries associated with an entity. The second calculator is configured to select a clicked query from the entity-specific query log, to select a query group associated with the selected clicked query from the one or more groups of related queries, and to calculate a normalized group click frequency (NGCF) for each query of the selected query group. The third calculator is configured to calculate relevancy scores for a plurality of queries.

These and other objects, advantages and features will become readily apparent in view of the following detailed description of the invention. Note that the Summary and Abstract sections may set forth one or more, but not all exemplary embodiments of the present invention as contemplated by the inventor(s).

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a document retrieval system.

FIG. 2 shows an example query that may be submitted by a user to a search engine.

FIG. 3 shows an example query log.

FIG. 4 shows search results displayed on a webpage by a search engine in response to an example query.

FIG. 5 shows an example advertiser-specific query log.

FIG. 6 shows a query information generating system, according to an example embodiment of the present invention.

FIG. 7 shows a flowchart for generating a no-click query report, according to an example embodiment of the present invention.

FIG. 8 shows a block diagram example of the query information generating system of FIG. 6, according to an embodiment of the present invention.

FIG. 9 shows a block diagram of a no-click query determiner, according to an example embodiment of the present invention.

FIG. 10 shows a flowchart for generating a no-click query report, according to an example embodiment of the present invention.

FIG. 11 shows a block diagram example of the query information generating system of FIG. 6, according to an embodiment of the present invention.

FIG. 12 shows a block diagram of an example computer system in which embodiments of the present invention may be implemented.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

### Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

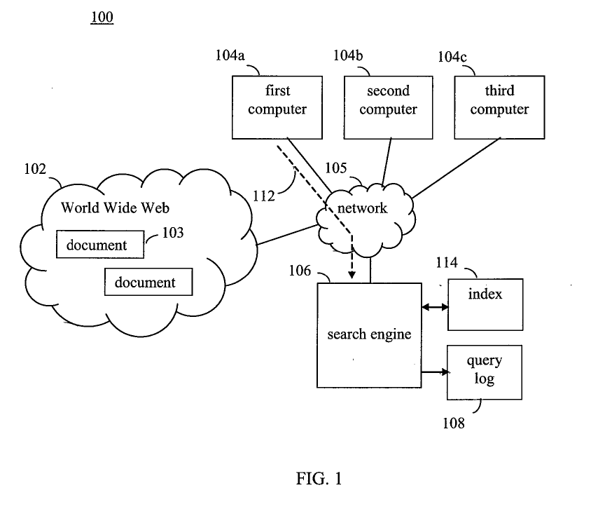

Embodiments of the present invention provide methods and systems that enable useful information regarding queries to be generated from search engine query logs. Such information may be used by entities, such as advertisers, to better target their advertisements to users. FIG. 1 shows an example environment in which embodiments of the present invention may be implemented. FIG. 1 is provided for illustrative purposes, and it is noted that embodiments of the present invention may be implemented in alternative environments. FIG. 1 shows a document retrieval system 100, according to an example embodiment of the present invention. As shown in FIG. 1, system 100 includes a search engine 106. One or more computers 104, such as first-third computers 104a-104c, are connected to a communication network 105. Network 105 may be any type of communication network, such as a local area network (LAN), a wide area network (WAN), or a combination of communication networks. In embodiments, network 105 may include the Internet and/or an intranet. Computers 104 can retrieve documents from entities over network 105. In embodiments where network 105 includes the Internet, a collection of documents, including a document 103, which form a portion of World Wide Web 102, are available for retrieval by computers 104 through network 105. On the Internet, documents may be identified/located by a uniform resource locator (URL), such as http://www.yahoo.com, and/or by other mechanisms. Computers 104 can access document 103 through network 105 by supplying a URL corresponding to document 103 to a document server (not shown in FIG. 1).

As shown in FIG. 1, search engine 106 is coupled to network 105. Search engine 106 accesses a stored index 114 that indexes documents, such as documents of World Wide Web 102. A user of computer 104a who desires to retrieve one or more documents relevant to a particular topic, but does not know the identifier/location of such a document, may submit a query 112 to search engine 106 through network 105. Search engine 106 receives query 112, and analyzes index 114 to find documents relevant to query 112. For example, search engine 106 may determine a set of documents indexed by index 114 that include terms of query 112. The set of documents may include any number of documents, including tens, hundreds, thousands, or even millions of documents. Search engine 106 may use a ranking or relevance function to rank documents of the retrieved set of documents in an order of relevance to the user. Documents of the set determined to most likely be relevant may be provided at the top of a list of the returned documents in an attempt to avoid the user having to parse through the entire set of documents.

Search engine 106 may be implemented in hardware, software, firmware, or any combination thereof. For example, search engine 106 may include software/firmware that executes in one or more processors of one or more computer systems, such as one or more servers. Examples of search engine 106 that are accessible through network 105 include, but are not limited to, Yahoo! Search™ (at http://www.yahoo.com), Ask.com™ (at http://www.ask.com), and Google™ (at http://www.google.com).

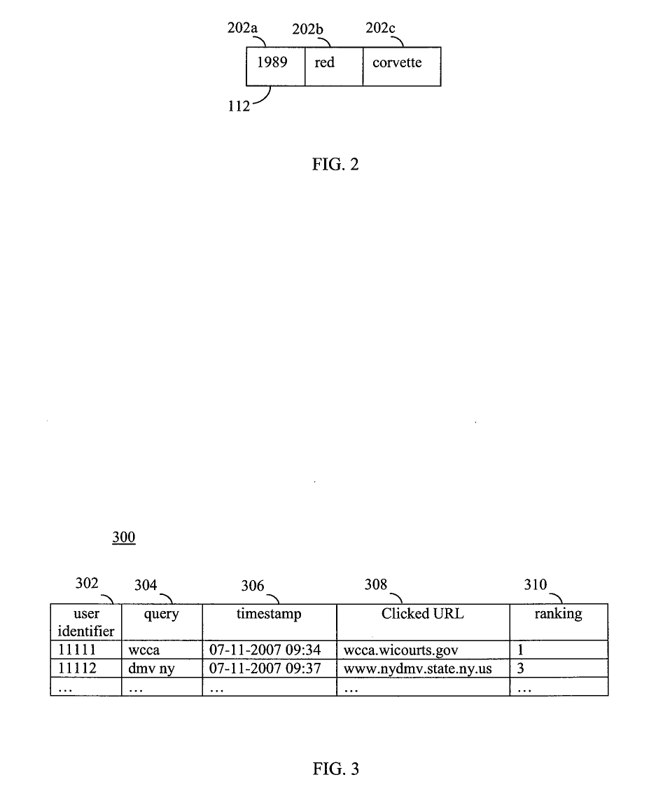

FIG. 2 shows an example query 112 that may be submitted by a user of one of computers 104a-104c of FIG. 1 to search engine 106. Query 112 includes one or more terms 202, such as first, second, and third terms 202a-202c shown in FIG. 2. Any number of terms 202 may be present in a query. As shown in FIG. 2, terms 202a-202c of query 112 are “1989,” “red,” and “corvette.” Search engine 106 applies these terms 202a-202c to index 114 to retrieve a document locator, such as a URL, for one or more indexed documents that match 1989,” “red,” and “corvette,” and may order the list of documents according to a ranking. As shown in FIG. 1, search engine 106 may generate a query log 108. Query log 108 is a record of searches that are made using search engine 106. Query log 108 may include a list of queries, by listing query terms (e.g., terms 202 of query 112) along with further information/attributes for each query, such as a list of documents resulting from the query, a list/indication of documents in the list that were selected/clicked on (“clicked”) by a user reviewing the list, a ranking of clicked documents, a timestamp indicating when the query is received by search engine 106, an IP (internet protocol) address identifying a unique device (e.g., a computer, cell phone, etc.)) from which the query terms were submitted, an identifier associated with a user who submits the query terms (e.g., a user identifier in a web browser cookie), and/or further information/attributes.

For instance, FIG. 3 shows a query log 300 as an example of query log 108 shown in FIG. 1. In the example of FIG. 3, query log 300 includes a first column 302, a second column 304, a third column 306, a fourth column 308, and a fifth column 310. First column 302 lists user identifiers (e.g., anonymous identification numbers) for users that submit queries to search engine 106. Second column 304 lists queries submitted by the users listed in column 302. Third column 306 lists a timestamp indicating a date/time at which the corresponding query listed in column 304 was submitted to search engine 106. Fourth column 308 lists one or more URLs of a resulting document list for the corresponding query listed in column 304 that were clicked by the user. Fifth column 310 lists a ranking in the resulting document list for the corresponding document listed in column 308. For example, a first row of query log 300 lists user identifier 11111 in column 302, “wcca” in column 304 as a query, a timestamp of 9:34 am, Jul. 11, 2007, in column 306, wcca.wicourts.gov as a clicked document URL in column 308 resulting from the query of “wcca,” and a ranking of 1 for wcca.wicourts.gov in the resulting document list.

Although data related to two submitted queries is shown in FIG. 3 for query log 300 for illustrative purposes, a query log may include any amount of data, including data for hundreds, thousands, and even millions of queries. Furthermore, it is noted that in column 308, query log 300 lists documents that were clicked by the user in the returned document list for the corresponding query in column 304. In another implementation of query log 300, documents that were not clicked by the user in the returned document list for the query of column 304 may also be listed in column 308 (or another column) for each query.

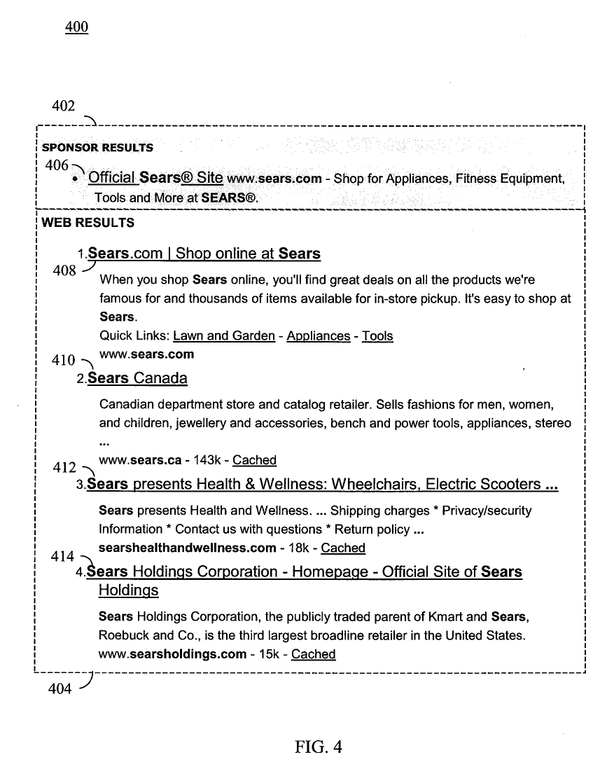

Various entities may provide content for display on search engine websites that is directed to the users of the search engine. For instance, advertisers may pay or otherwise compensate search engine websites for displaying their advertisements. A search engine website may display an advertisement in response to a designated query. For example, FIG. 4 shows search results displayed on a webpage 400 by search engine 106 in response to a query of “sears.” Search engine 106 may analyze the query “sears” to determine whether the query relates to a particular advertiser, and if so, may display an advertisement of the advertiser in the form of a sponsored link. In this example, search engine 106 determined that the query “sears” relates to Sears, Roebuck and Co., Hoffman Estates, Ill. (hereinafter “Sears Company”), which in the current example is an advertiser that provides advertisements to search engine 106. In webpage 400, which is generated in response to the “sears” query, search engine 106 displays an advertisement page portion 402 and a search results page portion 404. As shown in FIG. 4, advertisement page portion 402 includes an advertisement 406 in the form of advertisement text and a sponsored link (www.sears.com) of Sears Company. Search results page portion 404 lists search results for query “sears,” including documents/links 408, 410, 412, and 414 (further resulting document/links are not shown in FIG. 4 for purposes of brevity), in a standard fashion for search engine 106. In this manner, a search engine may display search results for a query, and may match a particular advertiser with computer users who may be interested in a product or service of the advertiser according to the query entered by the user.

Advertisers that advertise on search engine websites in this manner may desire information regarding the success of their advertisements. An advertiser-specific query log may be generated from search engine query logs to provide information regarding queries that relate to the specific advertiser. Typically, such advertiser-specific logs list queries listed in the search engine query logs that led to display of the advertiser's advertisement(s), along with counts of the number of appearances of those queries in the search engine query logs and/or further relevant information.

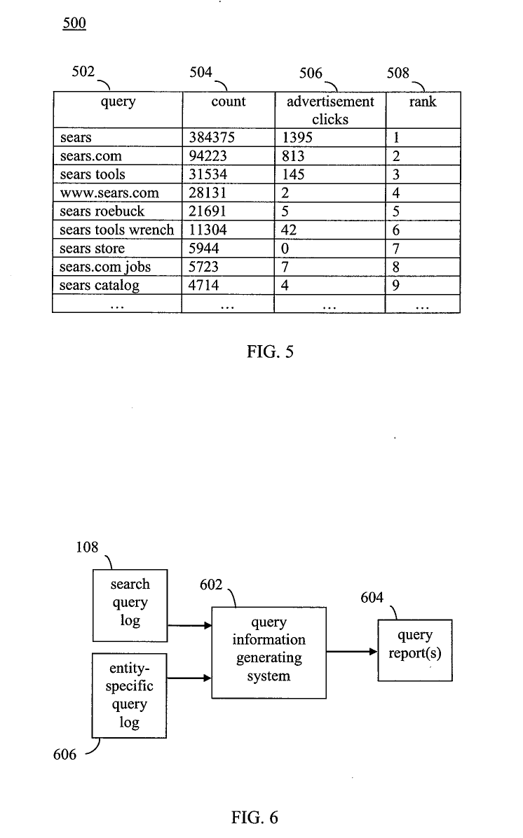

FIG. 5 shows an example advertiser-specific query log 500. Advertiser-specific query log 500 may be generated from any number of one or more search engine query logs. In the example of FIG. 5, advertiser-specific query log 500 includes a first column 502, a second column 504, a third column 506, and a fourth column 508. First column 502 lists queries submitted by the users. Second column 504 lists a count of a number of times that the corresponding query of column 502 appeared in the search engine query log(s). Third column 506 lists a number of times an advertisement (e.g., a sponsored link) of the advertiser was clicked on subsequent to being displayed on the search engine website in response to the query of column 502 (the present example assumes that the advertisement was displayed in response to each submission of the query of column 502 to the search engine). Fourth column 508 ranks the queries of column 502 according to the count in column 504 (advertiser-specific query log 500 is shown in FIG. 5 as sorted according to column 508, for ease of illustration). For example, a first row of advertiser-specific query log 500 lists query “sears” in column 502, a count number of 384,375 in column 504 for the query “sears,” a number of 1,395 clicks for an advertisement of the advertiser in column 506, and a ranking of 1 for the number of appearance of “sears” the search engine query log(s) for the advertiser.

Advertiser-specific query log 500, however, does not provide any information for the advertiser regarding other types of queries, including information regarding queries that did not lead to advertisements of advertisers to be displayed. Such information may be useful to advertisers for improving the performance of their advertisements. Embodiments of the present invention provide ways for extracting/generating useful information from query logs for entities (e.g., advertisers) regarding queries other than those that led to the advertiser's advertisements to be displayed and/or clicked. Example embodiments of the present invention are described in detail in the following section.

### Example Query Log Analysis Embodiments

Example embodiments are described for analyzing query logs and for generating information useful to entities, such as advertisers, regarding queries that do not lead their content (e.g., advertisements) to be displayed by a search engine website. Furthermore, embodiments are described for generating query recommendations to entities. The example embodiments described herein are provided for illustrative purposes, and are not limiting. Further structural and operational embodiments, including modifications/alterations, will become apparent to persons skilled in the relevant art(s) from the teachings herein.

FIG. 6 shows a query information generating system 602, according to an example embodiment of the present invention. As shown in FIG. 6, query information generating system 602 receives search query log 108 and an entity-specific query log 606. Entity-specific query log 606 may be a query log specific to any entity that displays content on a search engine website. For instance, entity-specific query log 606 may be advertiser-specific query log 500 generated for an advertising entity. Query log analyzing system 602 is configured to determine queries that have a relation to products and/or services of the entity, but that did not result in display of the content of the entity.

In the case where the entity is an advertiser, query information generating system 602 determines queries that may be of interest to the advertiser (e.g., related to the advertiser's products and/or services) that did not result in advertiser's advertisement(s) being displayed. In an embodiment, query information generating system 602 mines search query log 108 and entity-specific query log 606 for such queries. Learning about such queries is valuable for advertisers. Such queries may aid an advertiser in determining a gap between what the advertiser provides and what users are searching for. Such knowledge may enable the advertiser to learn about new trends, and/or to lead the advertiser to make a change in content presentation (e.g., improve an existing advertisement and/or generate new advertisements) to improve content quality, to make a change in inventory, to change targeting of the advertisement to improve user targeting, including entering the advertisement into a new space for the advertiser, and/or to make other changes in advertising, marketing, product/service development, product/service portfolio, etc. Embodiments can be incorporated into a bidding recommendation tool, acting as one of many experts, blended with a good strategy

As shown in FIG. 6, query information generating system 602 generates query reports 604, which may be output in a form that may be displayed, stored, and/or otherwise received and/or used, including a textual form, graphical form, and/or electronic file form. For example, in an embodiment, query report(s) 604 may include a first query report that lists significant queries that did not lead to display of advertisements (and optionally lists further types of queries). In another embodiment, query report(s) 604 may include a second query report that provides one or more query recommendations. Query information generating system 602 may include hardware, software, firmware, or any combination thereof, to perform its functions. Examples embodiments for generating query reports using query information generating system 602 are described in the following subsections.

### Example No-Click Query Report Generating Embodiments

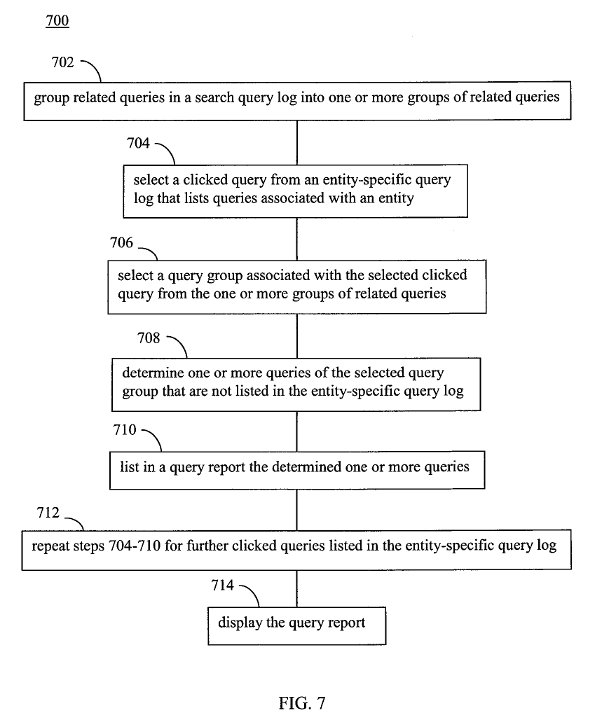

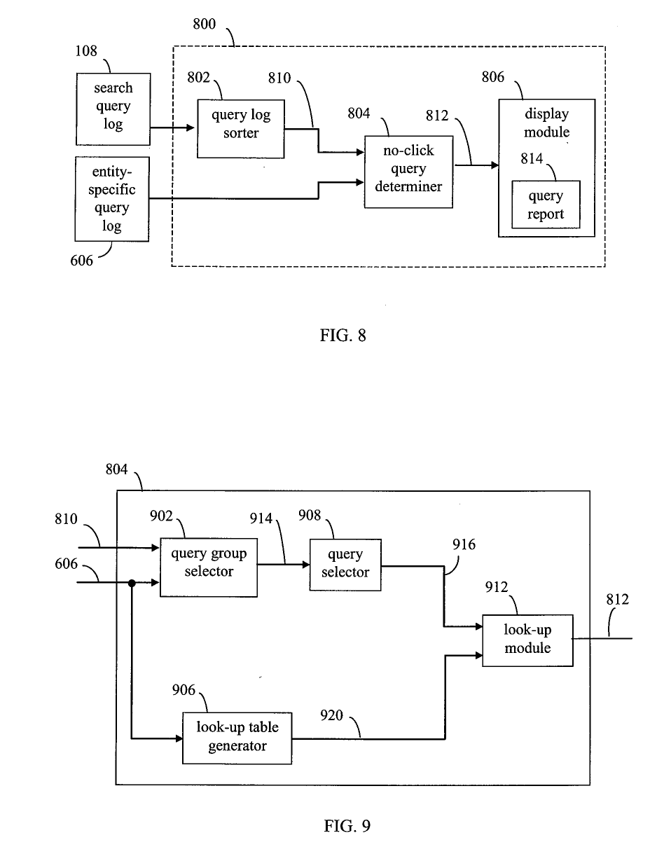

FIG. 7 shows a flowchart 700 for generating a no-click query report, according to an example embodiment of the present invention. Flowchart 700 may be performed by query information generating system 602. FIG. 8 shows a block diagram of a query information generating system 800, which is an example of query information generating system 602 of FIG. 6, according to an embodiment of the present invention. As shown in FIG. 8, in an embodiment, query information generating system 800 may include a query log sorter 802, a no-click query determiner 804, and a display module 806. Further structural and operational embodiments will be apparent to persons skilled in the relevant art(s) based on the discussion regarding flowchart 700. Not all steps of flowchart 700 need be performed in all embodiments, and the steps of flowchart 700 do not need to be performed in the order shown in FIG. 7. Flowchart 700 is described as follows with respect to system 800 shown in FIG. 8, for illustrative purposes.

Flowchart 700 begins with step 702. In step 702, related queries in a search query log are grouped into one or more groups of related queries. For example, in an embodiment, query log sorter 802 groups queries in search query log 108 (e.g., query log 300 shown in FIG. 3) into groups of related queries. For instance, lexically related queries may be grouped, such that if a first query contains all the query terms of a second query, the first and second queries are grouped together (along with any further lexically related queries). In other embodiments, related query terms may be grouped in other ways, such as by grouping query terms that have any number of one or more query terms in common, etc.

An example of groupings of related queries present in a search query log is shown below in Table 1. In Table 1, in a first group, each query contains the query term “sears.com,” and in a second group, each query contains the query term “circuit city.” A first column of Table 1 lists query terms, and a second column of Table 1 lists a number of times the query terms of the first column appear in the search query log:

TABLE 1

| query group | query | count |
|---|---|---|
| sears.com | www sears.com | 117188 |
| sears.com | sears.com | 94223 |
| sears.com | search sears.com | 32489 |
| sears.com | sears.com parts | 17766 |
| sears.com | sears.com coupons | 7119 |
| sears.com | sears.com jobs | 5723 |
| sears.com | sears.com careers | 132 |
| circuit city | circuit city electronics | 84272 |
| circuit city | circuit city PS3 | 66984 |
| circuit city | circuit city notebook | 11899 |
| circuit city | circuit city television | 10334 |

Any number of groups of related queries, such as those shown above in Table 1, may be generated for the search query log by query log sorter 802. Such groups may include related query groups related to the advertiser (e.g., groups based on query terms “sears,” “Roebuck,” “craftsman tools,” etc. for Sears Company) and related query groups that are not necessarily related to the advertiser (e.g., groups based on the terms “Steven Spielberg,” “tennis,” “stock market,” etc.).

As shown in FIG. 8, query log sorter 802 generates a sorted query log 810. Sorted query log 810 includes the one or more groups of related queries generated by query log sorter 802. Note that query log sorter 802 may determine all of the groups of related queries up front, or may determine groups on a one-by-one basis, as needed by subsequent functionality of system 800.

In step 704, a clicked query is selected from an entity-specific query log that lists queries associated with an entity. For example, in an embodiment, no-click query determiner 804 receives entity-specific query log 606, and selects a clicked query listed in entity-specific query log 606. No-click query determiner 804 may select any clicked query listed in entity-specific query log 606. For instance, no-click query determiner 804 may select the first clicked query listed in entity-specific query log 606 during a first iteration of step 704, and may select a next clicked query listed in entity-specific query log 606 during each subsequent iteration of step 704. Alternatively, no-click query determiner 804 may iterate through queries of entity-specific query log 606 in an alternative order, in a random fashion, or in any other manner.

In an example, entity-specific query log 606 may be advertiser-specific log 500 shown in FIG. 5. In such an example, no-click query determiner 804 may select the clicked query “sears.com” from advertiser-specific query log 500. As indicated in column 506 of advertiser-specific query log 500, query “sears store” has 0 advertisement clicks, and thus is not a clicked query that is eligible for selection in step 704.

In step 706, a query group associated with the selected clicked query is selected from the one or more groups of related queries. For example, in an embodiment, no-click query determiner 804 receives sorted query log 810, and selects the group of related queries in sorted query log 810 associated with the clicked query selected in step 704.

Following the current example, where “sears.com” is the clicked query selected in step 704, the group of related queries shown above in Table 1 may be the group of related queries in sorted query log 810 associated with “sears.com.”

In step 708, one or more queries of the selected query group that are not listed in the entity-specific query log are determined. For example, in an embodiment, no-click query determiner 804 determines one or more queries of the query group selected in step 706 that are not listed in entity-specific query log 606.

Following the current example, where the group of related queries is shown above in Table 1 for query “sears.com,” and advertiser-specific query log 500 shown in FIG. 5 is entity-specific query log 606, no-click query determiner 804 may determine that the following query terms (shown in Table 2 below) of the group associated with “sears.com” are not listed in advertiser-specific query log 500:

TABLE 2

| query | count |
|---|---|
| www sears.com | 117188 |
| search sears.com | 32489 |
| sears.com parts | 17766 |
| sears.com coupons | 7119 |
| sears.com careers | 132 |

(The queries “sears.com” and “sears.com jobs” are listed in both of Table 1 and advertiser-specific query log 500 shown in FIG. 5, and thus are not listed above in Table 2 by no-click query determiner 804).

In step 710, the determined one or more queries are listed in a query report. In an embodiment, no-click query determiner 804 generates/maintains a query report, which lists the queries of the selected query group that are not listed in the entity-specific query log, as determined in step 710. For example, the determined queries shown above in Table 2 for “sears.com” may be listed in a query report.

In step 712, steps 704-710 are repeated for further clicked queries listed in the entity-specific query log. In embodiments, steps 704-710 are repeated for further clicked queries listed in entity-specific query log 606 to determine further queries of related query groups that are not listed in entity-specific query log 606. For instance, in the current example, steps 704-710 may be repeated for clicked queries “sears,” “sears tools,” “www.sears.com,” “sears roebuck,” “sears tools wrench,” “sears.com jobs,” “sears catalog,” etc., listed in advertiser-specific query log 500 shown in FIG. 5.

For instance, another iteration of steps 704-710 is described as follows, continuing the current example. In step 704, the clicked query term “sears tools” may be selected from advertiser-specific query log 500. The following query group (formed in step 702) related to “sears tools” may be selected in step 706:

TABLE 3

| query | count |
|---|---|
| sears tools | 31534 |
| sears tools craftsman | 30992 |
| sears tools wrench | 11304 |
| sears tools saw | 13 |

The following queries of the query group of “sears tools” shown above in Table 3 may be determined in step 708 to not be listed in advertiser-specific query log 500 by performing a comparison:

TABLE 4

| query | count |
|---|---|
| sears tools craftsman | 30992 |
| sears tools saw | 13 |

The determined queries shown in Table 4 for “sears tools” may be added to/listed in the query report, in step 710.

As shown in FIG. 8, no-click query determiner 804 generates query report data 812, which includes the queries determined in step 710 for each iteration of steps 704-710.

In step 714, the query report is displayed. For example, in an embodiment, display module 806 receives query report data 812, and generates a query report 814 providing a textual and/or graphical display of query report data 812. Query report 814 may be referred to as a “no-click query report.” Query report 814 may appear as shown in Table 5 below for the data shown in Tables 2 and 4 above:

TABLE 5

| | | clicks in |
|---|---|---|
| clicked | | search |
| query | related no-click query | query log |
| sears.com | www sears.com | 117188 |
| | search sears.com | 32489 |
| | sears.com parts | 17766 |
| | sears.com coupons | 7119 |
| | sears.com careers | 132 |
| sears tools | sears tools craftsman | 30992 |
| | sears tools saw | 13 |

As shown above, Table 5 only includes queries (in the second column) related to the clicked query (in the first column) that did not lead to display or clicks of the advertiser's advertisement(s). In another embodiment, query report 814 may include a listing of queries related to the clicked query that were clicked. For example, query report 814 may appear as follows in Table 6, showing queries that led to clicks of advertisements (indicated in the third column with a number of clicks of the advertisement) and queries that did not lead to clicks of advertisements (indicated by “no clicks” in the third column):

TABLE 6

| | | | count in |
|---|---|---|---|
| clicked | | clicks of | search |
| query | related query | advertisement | query log |
| sears.com | www sears.com | no clicks | 117188 |
| | search sears.com | no clicks | 32489 |
| | sears.com parts | no clicks | 17766 |
| | sears.com coupons | no clicks | 7119 |
| | sears.com jobs | 8 | 5723 |
| | sears.com careers | no clicks | 132 |
| sears tools | sears tools craftsman | no clicks | 30992 |
| | sears tools wrench | 42 | 11304 |
| | sears tools saw | no clicks | 13 |

In embodiments, query report 814 may be displayed by display module 806 as shown above for Tables 5 and/or 6, or in any other manner, including any combination or textual and/or graphical features. For instance, an expandable graphical user interface (GUI) view may also be used to display query report 814. Furthermore, query report 814 may include further information than is shown in Tables 5 and 6, including further information regarding the clicked queries and related queries from search query log 108 and/or entity-specific query log 606 (e.g., query rankings, etc.), as desired for a particular application. Query report 814 may optionally be sorted in any manner, in ascending or descending order, according to any parameter, including alphabetically by query, by number of advertisement clicks, appearance count in search query log, etc.

Query log sorter 802, no-click query determiner 804, and display module 806 may be implemented in hardware, software, firmware, or any combination thereof. For instance, display module 806 may be implemented in any manner to enable display of query report 814, such as including a display (e.g., a cathode ray tube (CRT) monitor, a flat panel display such as an LCD (liquid crystal display) panel, or other display mechanism) and/or further display related functionality.

No-clicked query determiner 804 may be configured in any manner to perform its functions. For instance, FIG. 9 shows a block diagram of no-click query determiner 804, according to an example embodiment of the present invention. As shown in FIG. 9, no-click query determiner 804 includes a query group selector 902, a look-up table generator 906, a query selector 908, and a look-up module 912. Query group selector 902 is configured to perform steps 704 and 706 of flowchart 700. As shown in FIG. 9, query group selector 904 receives sorted query log 810 and entity-specific query log 606. Query group selector 902 selects a query group from sorted query log 810 based on a clicked query selected from entity-specific query log 606, and generates a selected query group 914.

Look-up table generator 906, query selector 908, and look-up module 912 are configured to perform step 708 of flowchart 700. As shown in FIG. 9, look-up table generator 906 receives entity-specific query log 606. Look-up table generator 906 generates a look-up table 920 from entity-specific query log 606. Look-up table generator 906 may optionally include a hash generator that applies a hash function to the queries in entity-specific query log 606 (e.g., to reduce a size of each query listed in entity-specific query log 606), and the hashed queries are entered into look-up table 920. Any hash function may be applied, as would be known to persons skilled in the relevant art(s).

Query selector 908 receives selected query group 914, and transmits a selected query 916 of selected query group 914. Look-up module 912 receives selected query group 914 and look-up table 920. When a hash function is performed by look-up table generator 906, look-up module 912 may apply a hash function to selected query 916, to reduce a size of the query received in selected query 916. Look-up module 912 attempts to look-up selected query 916 in look-up table 920, to determine whether the query of selected query 916 is not present in entity-specific query log 606. Query selector 908 and look-up module 912 repeat this process for each query of selected query group 914, to determine any queries of selected query group 914 that are not present in entity-specific query log 606. As shown in FIG. 9, look-up module 912 generates query report data 812.

When hashed data is generated and used in the embodiment of FIG. 9, look-up module 912 is enabled to more quickly perform look-ups, decreasing an amount of required processing time. In further embodiments, system 800 may be implemented in other ways.

### Example Query Recommendation Report Generating Embodiments

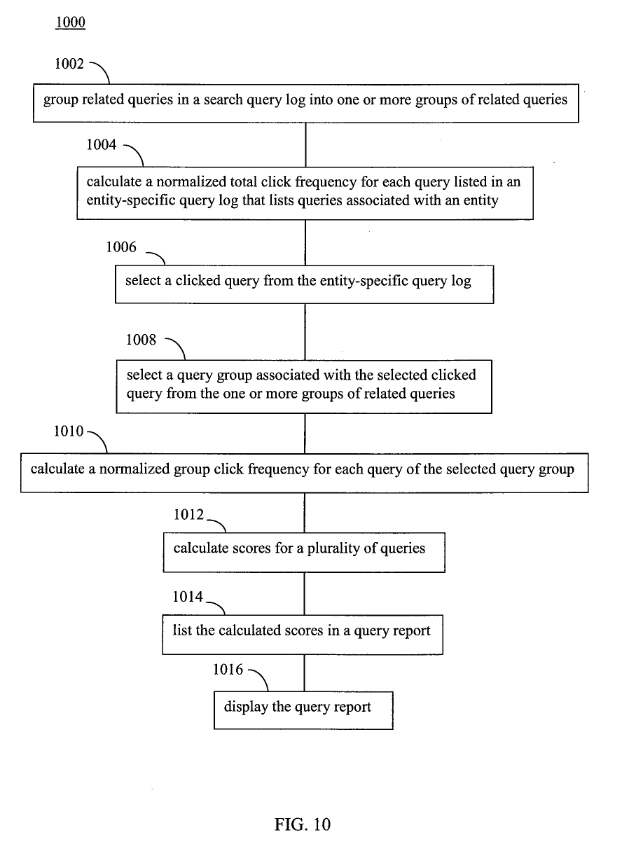

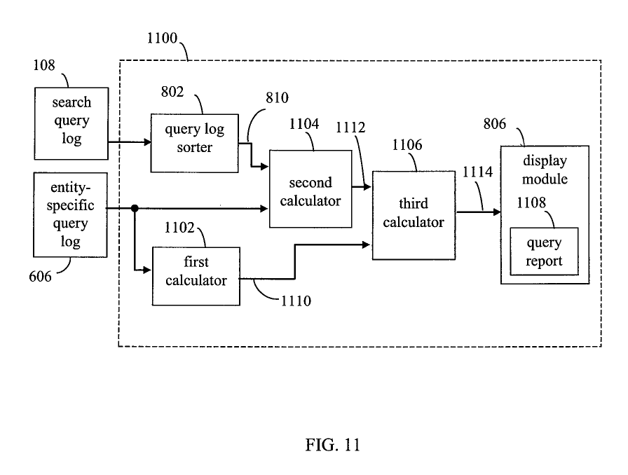

As described above with respect to FIG. 6, query report(s) 604 may include a second query report that provides one or more query recommendations. FIG. 10 shows a flowchart 1000 for generating a query report that includes one or more query recommendations, according to an example embodiment of the present invention. Flowchart 1000 may be performed by query information generating system 602. FIG. 11 shows a block diagram of a query information generating system 1100, which is an example of query information generating system 602 of FIG. 6, according to an embodiment of the present invention. As shown in the embodiment of FIG. 11, query information generating system 1100 may include query log sorter 802, a first calculator 1102, a second calculator 1104, a third calculator 1106, and display module 806. In an embodiment, system 800 of FIG. 8 and system 1100 of FIG. 11 may be combined to form an embodiment of system 602 of FIG. 6 that generates multiple types of query reports. Further structural and operational embodiments will be apparent to persons skilled in the relevant art(s) based on the discussion regarding flowchart 1000. Not all steps of flowchart 1000 need be performed in all embodiments, and the steps of flowchart 1000 do not need to be performed in the order shown in FIG. 10. Flowchart 1000 is described as follows with respect to system 1100 shown in FIG. 11, for illustrative purposes.

Flowchart 1000 begins with step 1002. In step 1002, related queries in a search query log are grouped into one or more groups of related queries. For example, in a similar fashion to the description provided above with respect to FIG. 8, query log sorter 802 groups queries in search query log 108 (e.g., query log 300 shown in FIG. 3) into groups of related queries. An example of groupings of related queries present in a search query log is shown below in Table 7 (a reproduction of Table 1 above). In Table 7, in a first group, each query contains the query term “sears.com,” and in a second group, each query contains the query term “circuit city”:

TABLE 7

| query group | query | count |
|---|---|---|
| sears.com | www sears.com | 117188 |
| sears.com | sears.com | 94223 |
| sears.com | search sears.com | 32489 |
| sears.com | sears.com parts | 17766 |
| sears.com | sears.com coupons | 7119 |
| sears.com | sears.com jobs | 5723 |
| sears.com | sears.com careers | 132 |
| circuit city | circuit city electronics | 84272 |
| circuit city | circuit city PS3 | 66984 |
| circuit city | circuit city notebook | 11899 |
| circuit city | circuit city television | 10334 |

As shown in FIG. 11, query log sorter 802 generates a sorted query log 810. Sorted query log 810 includes the one or more groups of related queries generated by query log sorter 802.

In step 1004, a normalized total click frequency is calculated for each query listed in an entity-specific query log that lists queries associated with an entity. For example, in an embodiment, first calculator 1102 receives entity-specific query log 606, and calculates a normalized total click frequency for each query listed therein. In an embodiment, first calculator 1102 calculates a normalized total click frequency for each query listed in entity-specific query log 606 according to Equation 1 below:

NTCF(q)=countq/total count for log 606 Equation 1

where
q=a query,
NTCF(q)=the calculated normalized total click frequency for query q,
count_{q}=count listed in entity-specific query log 606 of a number of times query q appeared in search query log 108 (e.g., count listed in column 504 of FIG. 5 for query q), and
total count for log 606=total of counts listed in entity-specific query log 606 for all queries (e.g., sum of the counts listed of column 504 of FIG. 5).

In one example, advertiser-specific query log 500 shown in FIG. 5 may be received by first calculator 1102 as entity-specific query log 606. First calculator 1102 may calculate the normalized total click frequency for each query listed in advertiser-specific query log 500. For instance, the normalized total click frequency for query “sears.com” may be calculated as follows:

total count for log 606=384375+94223+31534+28131+21691+11304+5944+5723+4714=587639

NTCF(sears.com)=94233/587639=0.16036

Table 8 shown below lists a calculated normalized total click frequency for each query listed in advertiser-specific query log 500 in FIG. 5:

TABLE 8

| query | count | NTCF |
|---|---|---|
| sears | 384375 | 0.65410 |
| sears.com | 94223 | 0.16036 |
| sears tools | 31534 | 0.05366 |
| www.sears.com | 28131 | 0.04787 |
| sears roebuck | 21691 | 0.03691 |
| sears tools wrench | 11304 | 0.01924 |
| sears store | 5944 | 0.01012 |
| sears.com jobs | 5723 | 0.00974 |
| sears catalog | 4714 | 0.00802 |

As shown in FIG. 11, first calculator 1102 outputs a normalized entity-specific query log 1110 that contains the calculated normalized total click frequency for each query of entity-specific query log 606.

Steps 1006, 1008, and 1010 in flowchart 1000 are performed for each clicked query listed in entity-specific query log 606. In step 1006, a clicked query is selected from the entity-specific query log. For example, in a similar fashion as described above with respect to step 704, second calculator 1104 receives entity-specific query log 606, and selects a clicked query listed in entity-specific query log 606. Continuing the present example, second calculator 1104 may select the clicked query “sears.com” from advertiser-specific query log 500 in step 1006.

In step 1008, a query group associated with the selected clicked query is selected from the one or more groups of related queries. For example, in a similar fashion as described above with respect to step 706, second calculator 1104 receives sorted query log 810, and selects the group of related queries in sorted query log 810 associated with the clicked query selected in step 1006. Following the current example, where “sears.com” is the clicked query selected in step 1006, the group of related queries shown above in Table 7 may be the group of related queries in sorted query log 810 associated with “sears.com” that is selected from sorted query log 810.

In step 1010, a normalized group click frequency is calculated for each query of the selected query group. For example, in an embodiment, second calculator 1104 calculates the normalized group click frequency for each query of the selected group. In an embodiment, second calculator 1104 calculates a normalized group click frequency for a query of the selected group according to Equation 2 below:

NGCF(q′|scq)=countq′/group count for sorted query log 810 Equation 2

where
scq=the selected clicked query (selected in step 1006),
q′=a query of the selected group (selected in step 1008),
NGCF(q′|scq)=the calculated normalized group click frequency for query q′ for the query group associated with selected clicked query scq,
count_{q′}=count listed in sorted query log 810 for query q′, and
group count for sorted query log 810=sum of counts listed in sorted query log 810 for the queries of the group.

Following the current example, where Table 7 represents the selected group of related queries for query “sears.com,” second calculator 1102 may calculate the normalized group click frequency for each query in Table 7. For instance, the normalized group click frequency for query “sears.com parts” listed in Table 7 may be calculated as follows:

group count for sorted query log 810=117188+94223+32489+17766+7119+5723+132=274640

NGCF(sears.com parts|sears.com)=17766/274640=0.06469

Table 9 shown below lists calculated normalized group click frequency for each query listed in Table 7:

TABLE 9

| query group | query | count | NGCF |
|---|---|---|---|
| sears.com | www sears.com | 117188 | 0.42670 |
| sears.com | sears.com | 94223 | 0.34308 |
| sears.com | search sears.com | 32489 | 0.11830 |
| sears.com | sears.com parts | 17766 | 0.06469 |
| sears.com | sears.com coupons | 7119 | 0.02592 |
| sears.com | sears.com jobs | 5723 | 0.02084 |
| sears.com | sears.com careers | 132 | 0.00048 |
| circuit city | circuit city electronics | 84272 | 0.48575 |
| circuit city | circuit city PS3 | 66984 | 0.38610 |
| circuit city | circuit city notebook | 11899 | 0.06859 |
| circuit city | circuit city television | 10334 | 0.05957 |

As shown in FIG. 11, second calculator outputs normalized query groups 1112 that contains the calculated normalized group click frequency for each query of the selected query group.

As mentioned above, steps 1006, 1008, and 1010 in flowchart 1000 are performed for each clicked query listed in entity-specific query log 606, such that normalized query groups 1112 includes normalized group click frequencies for queries listed in a plurality of query groups. As a result, a single query may have any number of one or more calculated normalized group click frequencies if the query is listed in multiple related query groups. The query can have a normalized group click frequency calculated in step 1010 for each group of related queries in which the query is listed. For example, the query “sears.com parts” may be included in a group of related queries for the clicked query “sears.com” (as shown above), and in a group of related queries for the clicked query “parts.” In this example, the query “sears.com parts” may below to two related query groups, and thus may have the two example normalized group click frequencies shown in Table 10 below:

TABLE 10

| | NGCF |
|---|---|
| query group | of “sears.com parts” |
| sears.com | 0.06469 |
| parts | 0.32878 |

As indicated by the normalized group click frequencies in Table 10, the query “sears.com parts” was clicked more often (higher NGCF value) in relation to the queries of the query group “parts” as compared to queries of the query group “sears.com.” The query “sears.com parts” was clicked less often (lower NGCF value) relative to the queries of the query group “sears.com”.

In step 1012, scores for a plurality of queries are calculated. For example, in an embodiment, third calculator 1106 receives normalized query groups 1112 and normalized entity-specific query log 1110, and generates relevancy scores for each query that is grouped in a query group listed in normalized query groups 1112. A relatively high score represents a higher relevance for the query to the advertiser, while a relatively low score represents a lower relevance.

Such scores may be generated in a variety of ways to represent relevance. For example, in an embodiment, third calculator 1106 may calculate scores for queries of the selected query group according to Equation 3 shown below:

$$score ( {q}^{′} ) = {\sum }_{q ∈ Q} NGCF ( {q}^{′} \vert q ) \times NTCF ( q ) \qquad Equation 3$$

where
Q=the set of clicked queries listed in the entity-specific query log,
NGCF(q′|q)=the calculated normalized group click frequency for a query q′ for the query group associated with the selected clicked query q,
NTCF(q)=the calculated normalized total click frequency for the clicked query

Following the current example, where Table 8 lists the calculated normalized total click frequency for each query listed in advertiser-specific query log 500 in FIG. 5, and Table 10 lists the calculated normalized group click frequencies for the query “sears.com parts,” third calculator 1106 may calculate a relevancy score for “sears.com parts” according to Equation 3 as follows (assuming the normalized total click frequency for “parts” is 0.59430, for purposes of illustration):

$$\begin{matrix}score ( sears . com parts ) = NGCG ( sears . com parts \vert sears . com ) \times \\ NTCF ( sears . com ) + \\ ( NGCF ( sears . com parts \vert parts ) \times \\ NTCF ( parts ) ) \\ = 0.06469 \times 0.16036 + 0.32878 \times 0.59430 \\ = 0.20577\end{matrix}$$

In step 1014, the calculated scores are listed in a query report. As shown in FIG. 11, third calculator 1106 generates query report data 1114, which includes the scores determined in step 1012 for each query, and may include further query-related information, if desired.

First, second, and third calculators 1102, 1104, and 1106 may be implemented in hardware, software, firmware, or any combination thereof.

In step 1016, the query report is displayed. For example, in an embodiment, display module 806 receives query report data 1114, and generates a query report 1108 providing a textual and/or graphical display of query report data 1114. Query report 1108 may be referred to as a “query recommendation report” or a “queries without coverage report.” Query report 1108 may appear as follows in Table 11. Example data is shown in Table 11, for purposes of illustration:

TABLE 11

| | count of query | |
|---|---|---|
| | appearances in | |
| | search query | |
| query | log 108 | relevancy score |
| circuit city laptops notebooks | 4 | 1.50005798782256 |
| cheap portable mp3 players | 327 | 1.26744186046512 |
| circuit city com circuit city | 84 | 0.421258230103662 |
| circuit city online coupons | 194 | 0.298576829137843 |
| circuit city ps3 launch | 11 | 0.29745676380933 |
| circuit city black friday sale | 24 | 0.293030853764612 |
| circuit city consumer electronics | 9 | 0.25130219843131 |

As shown above, Table 11 includes queries (in the first column), a query count (in the second count), and a relevancy score (in the third column). The relevancy score indicates a relevancy of the query to the advertiser. Queries having high relevancy score may be recommended to the entity (e.g., advertiser) for use as a sponsored search term by the search engine, to cause display of the entity's content when submitted by a user into the search engine. Queries having low relevancy are less important to the advertiser, and may be considered to be discontinued if already in use by the advertiser.

In embodiments, query report 1108 may be displayed by display module 806 as shown above for Tables 5 and/or 6, or in any other manner, including any combination or textual and/or graphical features. Furthermore, query report 1108 may include further information than is shown in Tables 5 and 6, including further information regarding the clicked queries and related queries from search query log 108 and/or entity-specific query log 606 (e.g., query rankings, etc.), as desired for a particular application. Query report 1108 may optionally be sorted in any manner, in ascending or descending order, according to any parameter, including alphabetically by query, count of appearances in search query log, by relevancy score, etc.

Note that the relevance (usefulness) of a query to an advertiser may be modeled according to Equation 4 below:

$$P ( {q}^{′} \vert advertiser ) = {\sum }_{q ∈ Q} P ( {q}^{′} \vert q , advertiser ) \times P ( q \vert advertiser ) \qquad Equation 4$$

where
P(q′|advertiser)=the relevance of query q′ to the advertiser,
P(q′|q, advertiser)=the relevance of query q′ to the advertiser for the query group associated with the selected clicked query q, and
P(q|advertiser)=the relevance of query q to the advertiser.
   If an assumption is made that q′ is independent of the advertiser given q, Equation 4 can be rewritten as Equation 5 below:

$$P ( {q}^{′} \vert advertiser ) = {\sum }_{q ∈ Q} P ( {q}^{′} \vert q ) \times P ( q \vert advertiser ) \qquad Equation 5$$

Equation 3 described above is a form of Equation 5, where P(q′|q) is estimated from search query logs using the formulation of NGCF (normalized group click frequency).

According to further embodiments of the present invention for generatng the scores of step 1012, P(q′|q) may be estimated in alternative ways, including in more complex ways that include more parameters than used by NGCF calculations described above. For example, clicks and page views may be considered differently, and/or a position of a clicked page in a search result may be taken into account. For instance, if a web page resulting from a query is located in position 1 in the resulting list, then the web page likely has a higher chance of being clicked, and thus may be “normalized” for the positional effect. Thus, in embodiments, flowchart 1000 may incorporate alternatives to calculating normalized group click frequencies for P(q′|q) as described above (in step 1010) to be used to calculate query relevance scores (in step 1012).

In a similar manner, flowchart 1000 may incorporate alternatives to calculating normalized total click frequencies (NTCF) for P(q|advertiser) as described above (in step 1004) to be used to calculate query relevance scores (in step 1012). For example, P(q|advertiser) may include additional parameters than used by NTCF calculations described above, in embodiments.

In further embodiments, various smoothing techniques may be used in query relevance calculations. Still further, an advertiser hierarchy may be considered, and the probabilities of all terms in an advertiser's category (hierarchy) may be initialized to a nominal value.

### Example Computer Implementation

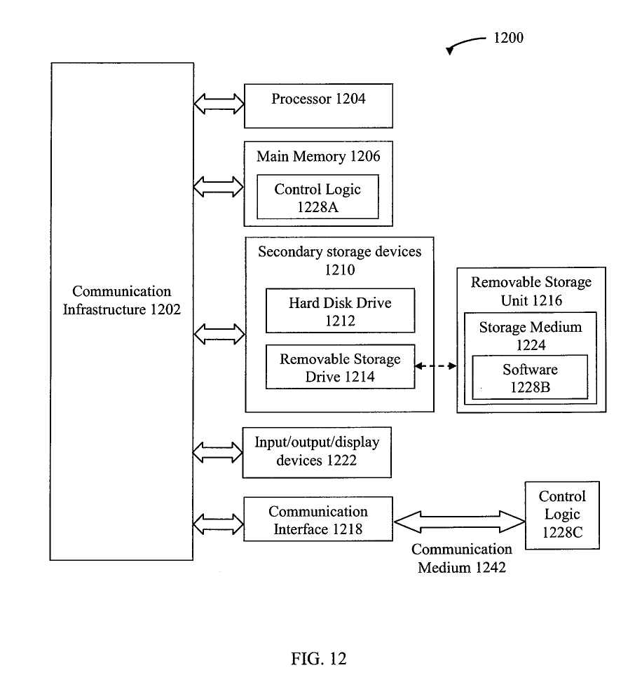

The embodiments described herein, including systems, methods/processes, and/or apparatuses, may be implemented using well known servers/computers, such as computer 1200 shown in FIG. 12. For example, search engine 106 of FIG. 1, query information generating systems 602, 800, and 1100 of FIGS. 6, 8, and 11, no-click query determiner 804 of FIG. 9, flowchart 700 shown in FIG. 7, and flowchart 1000 shown in FIG. 10, can be implemented using one or more computers 1200.

Computer 1200 can be any commercially available and well known computer capable of performing the functions described herein, such as computers available from International Business Machines, Apple, Sun, HP, Dell, Cray, etc. Computer 1200 may be any type of computer, including a desktop computer, a server, etc.

Computer 1200 includes one or more processors (also called central processing units, or CPUs), such as a processor 1204. Processor 1204 is connected to a communication infrastructure 1202, such as a communication bus. In some embodiments, processor 1204 can simultaneously operate multiple computing threads.

Computer 1200 also includes a primary or main memory 1206, such as random access memory (RAM). Main memory 1206 has stored therein control logic 1228A (computer software), and data.

Computer 1200 also includes one or more secondary storage devices 1210. Secondary storage devices 1210 include, for example, a hard disk drive 1212 and/or a removable storage device or drive 1214, as well as other types of storage devices, such as memory cards and memory sticks. For instance, computer 1200 may include an industry standard interface, such a universal serial bus (USB) interface for interfacing with devices such as a memory stick. Removable storage drive 1214 represents a floppy disk drive, a magnetic tape drive, a compact disk drive, an optical storage device, tape backup, etc.

Removable storage drive 1214 interacts with a removable storage unit 1216. Removable storage unit 1216 includes a computer useable or readable storage medium 1224 having stored therein computer software 1228B (control logic) and/or data. Removable storage unit 1216 represents a floppy disk, magnetic tape, compact disk, DVD, optical storage disk, or any other computer data storage device. Removable storage drive 1214 reads from and/or writes to removable storage unit 1216 in a well known manner.

Computer 1200 also includes input/output/display devices 1222, such as monitors, keyboards, pointing devices, etc.

Computer 1200 further includes a communication or network interface 1218. Communication interface 1218 enables the computer 1200 to communicate with remote devices. For example, communication interface 1218 allows computer 1200 to communicate over communication networks or mediums 1242 (representing a form of a computer useable or readable medium), such as LANs, WANs, the Internet, etc. Network interface 1218 may interface with remote sites or networks via wired or wireless connections.

Control logic 1228C may be transmitted to and from computer 1200 via the communication medium 1242. More particularly, computer 1200 may receive and transmit carrier waves (electromagnetic signals) modulated with control logic 1228C via communication medium 1242.

Any apparatus or manufacture comprising a computer useable or readable medium having control logic (software) stored therein is referred to herein as a computer program product or program storage device. This includes, but is not limited to, computer 1200, main memory 1206, secondary storage devices 1210, removable storage unit 1216 and carrier waves modulated with control logic 1228C. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of generating a no-click query report, comprising:
grouping related queries in a search query log into one or more groups of related queries;
selecting a clicked query from an entity-specific query log that lists queries associated with an entity;
selecting a query group associated with the selected clicked query from the one or more groups of related queries;
determining one or more queries of the selected query group that are not listed in the entity-specific query log; and
listing in a query report the determined one or more queries.

2. The method of 1, further comprising:
repeating said selecting a clicked query, said selecting a query group, said determining, and said listing, for further clicked queries listed in the entity-specific query log.

3. The method of claim 2, further comprising:
displaying the query report.

4. The method of claim 1, further comprising:
generating a hash from the entity-specific query log;
wherein said determining comprises:
determining whether a query of the selected query group is not listed in the entity-specific query log by generating a hash of the query and comparing the hash of the query to the hash of the entity-specific query log.

5. The method of claim 1, further comprising:
sorting the query report.

6. A method of generating a query recommendation report, comprising:
grouping related queries listed in a search query log into one or more groups of related queries;
calculating a normalized total click frequency (NTCF) for each clicked query listed in an entity-specific query log that lists queries associated with an entity;
for each clicked query listed in the entity-specific query log,
selecting a clicked query from the entity-specific query log,
selecting a query group associated with the selected clicked query from the one or more groups of related queries, and
calculating a normalized group click frequency (NGCF) for each query of the selected query group; and
calculating scores for a plurality of queries.

7. The method of claim 6, wherein said calculating scores for a plurality of queries comprises calculating a score for a query q′ of the plurality of queries according to
$$score ( {q}^{′} ) = {\sum }_{q ∈ Q} NGCF ( {q}^{′} \vert q ) \times NTCF ( q ) ,$$
where
Q=the set of clicked queries listed in the entity-specific query log,
NGCF(q′|q)=the calculated normalized group click frequency for query q′ for the query group associated with the selected clicked query q, and
NTCF(q)=the calculated normalized total click frequency for the clicked query q.

8. The method of claim 7, further comprising:
listing the calculated scores in a query report.

9. The method of claim 8, further comprising:
displaying the query report.

10. A query information reporting system, comprising:
a query log sorter configured to group related queries in a search query log into one or more groups of related queries; and
a no-click query determiner configured to select a clicked query from an entity-specific query log that lists queries associated with an entity;
wherein the no-click query determiner is configured to select a query group associated with the selected clicked query from the one or more groups of related queries; and
wherein the no-click query determiner is configured to determine any query of the selected query group that is not listed in the entity-specific query log.

11. The system of 10, wherein the no-click query determiner is configured to select one or more additional clicked queries from the entity-specific query log, to select one or more query groups associated with the one or more additional selected clicked queries, and to determine any queries of the one or more selected query groups that are not listed in the entity-specific query log.

12. The system of claim 11, wherein the no-click query determiner is configured to generate a query report that includes queries determined to not be listed in the entity-specific query log.

13. The system of claim 10, further comprising:
a hash generator configured to generate a hash from the entity-specific query log;
wherein the no-click query determiner is configured to determine whether a query of the selected query group is not listed in the entity-specific query log by generating a hash of the query and comparing the hash of the query to the hash of the entity-specific query log.

14. A query information reporting system, comprising:
a query log sorter configured to group related queries in a search query log into one or more groups of related queries;
a first calculator configured to calculate a normalized total click frequency (NTCF) for each query listed in an entity-specific query log that lists queries associated with an entity;
a second calculator configured to select a clicked query from the entity-specific query log, to select a query group associated with the selected clicked query from the one or more groups of related queries, and to calculate a normalized group click frequency (NGCF) for each query of the selected query group; and
a third calculator configured to calculate scores for a plurality of queries.

15. The system of claim 14, wherein the third calculator is configured to calculate a score for each query q′ of the plurality of queries according to
$$score ( {q}^{′} ) = {\sum }_{q ∈ Q} NGCF ( {q}^{′} \vert q ) \times NTCF ( q ) ,$$
where
Q=the set of clicked queries listed in the entity-specific query log,
NGCF(q′|q)=the calculated normalized group click frequency for query q′ for the query group associated with the selected clicked query q, and
NTCF(q)=the calculated normalized total click frequency for the clicked query q.

16. The system of claim 15, wherein the third calculator is configured to generate a query report that includes the calculated scores.

17. A computer program product comprising a computer usable medium having computer readable program code means embodied in said medium for generating a no-click query report, comprising:
a first computer readable program code means for enabling a processor to group related queries in a search query log into one or more groups of related queries;
a second computer readable program code means for enabling a processor to select a clicked query from an entity-specific query log that lists queries associated with an entity;
a third computer readable program code means for enabling a processor to select a query group associated with the selected clicked query from the one or more groups of related queries;
a fourth computer readable program code means for enabling a processor to determine one or more queries of the selected query group that are not listed in the entity-specific query log; and
a fifth computer readable program code means for enabling a processor to generate a query report that lists the determined one or more queries.

18. The computer program product of claim 17, further comprising:
a sixth computer readable program code means for enabling a processor to generate a hash from the entity-specific query log;
wherein said fourth computer readable program code means comprises:
a seventh computer readable program code means for enabling a processor to determine whether a query of the selected query group is not listed in the entity-specific query log by generating a hash of the query and comparing the hash of the query to the hash of the entity-specific query log.

19. A computer program product comprising a computer usable medium having computer readable program code means embodied in said medium for generating a query recommendation report, comprising:
a first computer readable program code means for enabling a processor to group related queries in a search query log into one or more groups of related queries;
a second computer readable program code means for enabling a processor to calculate a normalized total click frequency for each query listed in an entity-specific query log that lists queries associated with an entity;
a third computer readable program code means for enabling a processor to select at least one clicked query from the entity-specific query log;
a fourth computer readable program code means for enabling a processor to select a query group associated with each selected clicked query from the one or more groups of related queries;
a fifth computer readable program code means for enabling a processor to calculate a normalized group click frequency for each query of each selected query group; and
a sixth computer readable program code means for enabling a processor to calculate scores for a plurality of queries.

20. The computer program product of claim 19, wherein said sixth computer readable program code means comprises:
a seventh computer readable program code means for enabling a processor to calculate a score for each query q′ of the plurality of queries according to
$$score ( {q}^{′} ) = {\sum }_{q ∈ Q} NGCF ( {q}^{′} \vert q ) \times NTCF ( q ) ,$$
where
Q=the set of clicked queries listed in the entity-specific query log,
NGCF(q′|q)=the calculated normalized group click frequency for query q′ for the query group associated with the selected clicked query q, and
NTCF(q)=the calculated normalized total click frequency for the clicked query q.

21. The computer program product of claim 20, further comprising:
an eighth computer readable program code means for enabling a processor to generate a query report that lists the calculated scores.
